(19) United States
(12) Patent Application Publication
(10) Pub. No.: US 2008/0168165 A1
(43) Pub. Date: Jul. 10, 2008

(54) SERVICE PROVISIONING SYSTEM, SERVICE PROVISIONING EQUIPMENT AND METHOD THEREFOR

(76) Inventor: Yasuhiro Araki, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/969,110

(22) Filed: Jan. 3, 2008

(30) Foreign Application Priority Data
Jan. 5, 2007 (JP) JP2007-000765

(51) Int. Cl. G06F 15/173

(52) U.S. Cl. 709/223

(57) ABSTRACT

To provide a service provisioning system, a service provisioning equipment, and a method therefor, which provide a user terminal with a service. An SCIM server creates service orchestration information, and performs a processing of storing the service orchestration information in an XML document management server (XDMS). The SCIM server also performs a processing for providing a service to a user terminal based on the service orchestration information. The SCIM server further performs a processing for setting up a session between the user terminal and an application server (AS) to provide the service to the user terminal. The SCIM server performs a processing for orchestrating a plurality of services into a new service and supplying the new service to the user terminal.

### PRIORITY CLAIM

The present invention claims priority to Japanese Patent Application Serial No. JP 2007-000765 filed on Jan. 5, 2007, the disclosure of which is hereby incorporated by reference in its entirety.

### TECHNICAL FIELD

The present invention relates to a service provisioning system, a service provisioning equipment, and a method therefor.

### BACKGROUND

U.S. Patent Application Publication Serial No. 2005/0278447 to Hariprasad et al. discloses a method of connecting a provisioning system with a home subscriber server (HSS) through an Sh interface, and using the Sh interface as a provisioning interface. In addition, Japan Patent No. 2006-217574 to Lucent Technology Inc. discloses a method for decomposing initial filter criteria (iFCs) into a user-specific portion and a user-independent portion, for example, to thereby deploy, provision, and store the initial filter criteria (iFCs) for a mobile IP network.

### SUMMARY

The present invention has been made against the above-mentioned backdrops, and therefore an object of the present invention is to provide a service provisioning system and a service provisioning equipment which serve to provide a user terminal with a service, and a method therefor.

### MEANS FOR SOLVING THE PROBLEM

To achieve the above-mentioned objective, according to the present invention, there is provided a service provisioning system, including: a plurality of service information management devices for managing first service information on a plurality of first services and providing the plurality of first services; a service provisioning processing device for performing a processing for providing a second service to a user terminal; and a service provisioning information management device for managing service provisioning information that is used by the service provisioning processing device to provide the second service to a user, in which the service provisioning processing device includes: service generator for generating the second service based on the plurality of first service information; service provisioning information creator for creating the service provisioning information; service provisioning information storing device for causing the service provisioning information management device to store therein the service provisioning information; and service provisioning information retrieving device for retrieving the service provisioning information from the service provisioning information management device.

Preferably, the service generator generates the second service by combining the plurality of first service information.

Also preferably, the service provisioning processing device further includes service invoking device for invoking the first service from the service information management device by using the second service; and the service information management device provides the first service invoked by the service invoking device.

Preferably, the service provisioning processing device further includes state information acquiring device for acquiring state information on another node; and the service provisioning information creator creates the service provisioning information based on the state information.

Preferably, the service provisioning information management device further includes: service provisioning information updating device for updating the service provisioning information; update notification request receiving device for receiving an update notification request from another node; and update notification transmitting device for transmitting an update notify to the another node based on the update notify request if the service provisioning information is updated.

Preferably, the service provisioning processing device further includes: update notification requesting device for requesting the service provisioning information management device to transmit the update notification if the service provisioning information is updated; and update notification receiving device for receiving the update notification from the service provisioning information management device.

Preferably, the service provisioning information includes: a candidate entity service list that is used for the user terminal to select the second service; and display information for displaying the candidate entity service list on the user terminal; and the service provisioning processing device provides the second service selected by the user terminal.

Preferably, the service provisioning system further includes a user information management device for managing user information on a user, and the service provisioning processing device provides the second service based on the user information.

Preferably, the service provisioning processing device further includes user information acquiring device for acquiring the user information from the user information management device; and the service provisioning information creator creates the service provisioning information based on the user information.

Further, the service provisioning device according to the present invention relates to a service provisioning processing device for performing a processing for providing a service to a user terminal, which includes: service generator for generating a second service based on information on a first service; service provisioning information creator for creating service provisioning information that is used for providing the second service; and service providing device for providing the second service to the user terminal based on the service provisioning information.

Further, a service provisioning method according to the present invention relates to a service provisioning method of providing a user terminal with a service, which includes: a service information managing step of managing first service information on a first service; a service generating step of generating a second service based on the first service information; a service provisioning information creating step of creating the service provisioning information that is used for providing the second service; a service provisioning information storage step of storing the service provisioning information; a service provisioning information retrieving step of retrieving the service provisioning information stored in the service provisioning information storage step; and a service providing step of providing the second service to the user terminal based on the service provisioning information.

### EFFECT OF THE INVENTION

According to the present invention, it is possible to provide a service provisioning system and a service provisioning equipment for effectively providing a service to a user terminal, and a method therefor.

### BEST MODE FOR CARRYING OUT THE INVENTION

Hereinafter, description will be made of an embodiment of the present invention.

### BRIEF DESCRIPTION OF THE DRAWINGS

FIG. 1 shows a diagram illustrating a configuration of a service provisioning system according to the embodiment of the present invention, to which a service providing method is applied.

FIG. 2 shows a diagram illustrating a hardware configuration of an SCIM server, an XML document management server, an application server, a home subscriber server, and an S-CSCF server, which are shown in FIG. 1.

FIG. 3 shows diagram illustrating a hardware configuration of a user terminal shown in FIG. 1.

FIG. 4 shows a diagram illustrating a configuration of an SCIM program that runs on the SCIM server shown in FIG. 1.

FIG. 5 shows a diagram illustrating a configuration of a session processing section shown in FIG. 4.

FIG. 6 shows a diagram illustrating a configuration of an XDMS program that runs on the XML document management server shown in FIG. 1.

FIG. 7 shows a diagram illustrating a configuration of a context information storage section shown in FIG. 6.

FIG. 8 shows a diagram illustrating a configuration of a service orchestration information storage section shown in FIG. 6.

FIG. 9 shows a diagram illustrating a configuration of an application server program that runs on the application server shown in FIG. 1.

FIG. 10 shows a diagram illustrating a configuration of a home subscriber server program that runs on the home subscriber server shown in FIG. 1.

FIG. 11 shows a diagram illustrating a configuration of a user terminal program that runs on the user terminal shown in FIG. 1.

FIG. 12 shows a sequence diagram exemplifying a mode in which the SCIM server receives a notify from the XML document management server and acquires updated information.

FIGS. 13(A) and 13(B) show diagrams exemplifying information exchanged between the respective nodes in the sequence shown in FIG. 12.

FIG. 14 shows a sequence diagram exemplifying a mode in which the user terminal stores information in the XML document management server.

FIG. 15 shows a diagram exemplifying information transmitted from the user terminal to the XML document management server in the sequence shown in FIG. 14.

FIG. 16 shows a sequence diagram exemplifying a mode in which the SCIM server stores service orchestration information in the XML document management server.

FIG. 17 shows a diagram exemplifying information transmitted from the SCIM server to the XML document management server in the sequence shown in FIG. 16.

FIG. 18 shows a sequence diagram exemplifying a mode in which the user terminal acquires the service orchestration information from the XML document management server.

FIGS. 19(A) and 19(B) show diagrams exemplifying information exchanged between the respective nodes in the sequence shown in FIG. 18.

FIG. 20 shows a sequence diagram exemplifying a mode in which the SCIM server performs a processing for providing the user terminal with a service based on the service orchestration information.

FIGS. 21(A)-(K) show diagrams exemplifying information exchanged between the respective nodes in the sequence shown in FIG. 20.

FIG. 22 shows another sequence diagram exemplifying the mode in which the SCIM server performs a processing for providing the user terminal with a service based on the service orchestration information.

FIG. 23 shows a diagram exemplifying information exchanged between the respective nodes in the sequence shown in FIG. 22.

FIG. 24 shows another sequence diagram exemplifying the mode in which the SCIM server performs a processing for providing the user terminal with a service based on the service orchestration information.

FIG. 25 shows a diagram exemplifying information exchanged between the respective nodes in the sequence shown in FIG. 24.

### DETAILED DESCRIPTION

Service Provisioning System 1

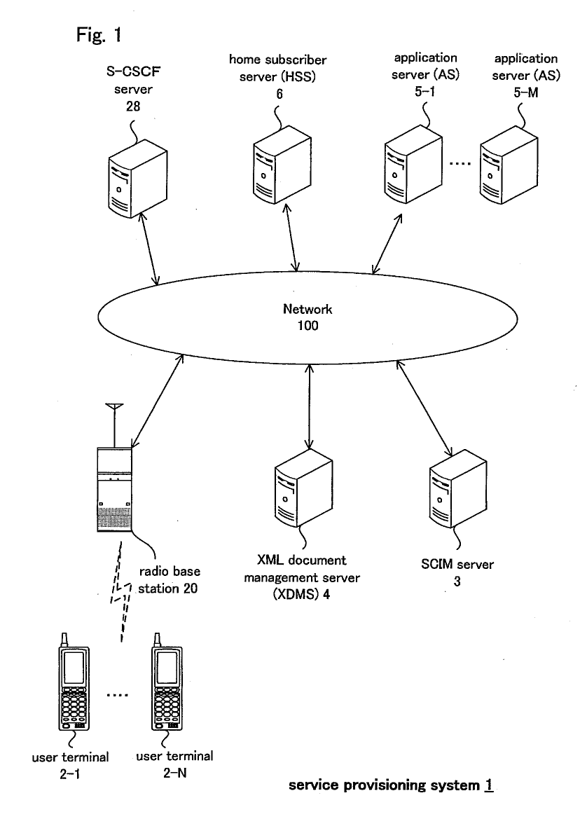

FIG. 1 is a diagram illustrating a configuration of a service provisioning system 1 according to the embodiment of the present invention, to which a service providing method is applied. As shown in FIG. 1, the service provisioning system 1 includes: a radio base station 20 for performing communication with user terminals 2-1 to 2-N (N is an integer equal to or larger than 1 and does not always hold the same number) such as mobile phones; a service capability interaction manager (SCIM) server 3; an extensible markup language (XML) document management server (XDMS) 4; application servers (ASs) 5-1 to 5-M (M is an integer equal to or larger than 1 and does not always hold the same number); a home subscriber server (HSS) 6; and a serving call session control function (S-CSCF) server 28, the entities being connected to one another via a network 100.

The service provisioning system 1 uses those configuration portions to provide the user terminal 2 with services such as an online game service and a group call service.

Note that when it is not identified which one of the plurality of the same entities, such as the user terminals 2-1 to 2-N, is to be referred to hereinafter, the one may simply be abbreviated as, for example, the user terminal 2. In addition, a device that can be an agent of information processing and communication in the service provisioning system 1, for example, the SCIM server 3, may generically be referred to as a “node” hereinafter. Further, optional two of the devices that compose the service provisioning system 1 shown in FIG. 1 can be combined into one unit as appropriate. In this embodiment, the radio base station 20, the SCIM server 3, the XML document management server (XDMS) 4, the home subscriber server (HSS) 6, and the S-CSCF server 28 are each provided as a single entity, but may each be a plurality of entities.

In each of the following figures, substantially the same entities and processing steps will be denoted by the same reference symbols.

In the service provisioning system 1, the user terminal 2 transmits/receives information to/from the SCIM server 3, the XML document management server (XDMS) 4, and the application server (AS) 5 via the radio base station 20, the network 100, and the S-CSCF server 28. The S-CSCF server 28 performs a routing processing between the user terminal 2 and another node. The S-CSCF server 28 also performs filtering based on information on users (user information) stored in the home subscriber server (HSS) 6, and controls setup of a session between the user terminal 2 and another node.

The SCIM server 3 creates service orchestration information, and stores the service orchestration information in the XML document management server (XDMS) 4. The SCIM server 3 also performs a processing for providing a service to the user terminal 2 based on the service orchestration information. The SCIM server 3 further performs a processing for setting up a session between the user terminal 2 and the application server (AS) 5 in order to provide a service to the user terminal 2. The term “service orchestration information” used herein represents information for integrating a plurality of services provided by a plurality of application servers (ASs) 5 and orchestrating the plurality of services into a new service. In short, the SCIM server 3 performs a processing for orchestrating the plurality of services into a new service and supplying the new service to the user terminal 2.

The XML document management server (XDMS) 4 stores and manages the service orchestration information and context information in the form of an XML document. The XML document management server (XDMS) 4 also receives an update request and a store request for stored information from another node, and performs an update processing and a store processing for the information. In response to a request from another node, the XML document management server (XDMS) 4 transmits a notify that the stored information has been updated.

The application server (AS) 5 stores and manages necessary information for providing a specific service. The application server (AS) 5 also provides the specific service to the user terminal 2. The home subscriber server (HSS) 6 stores and manages user information on a user who uses the service provisioning system 1. Note that in general, information within the home subscriber server (HSS) 6 is not updated by the user terminal 2, but is updated by a management terminal (not shown) or the like.

Hardware

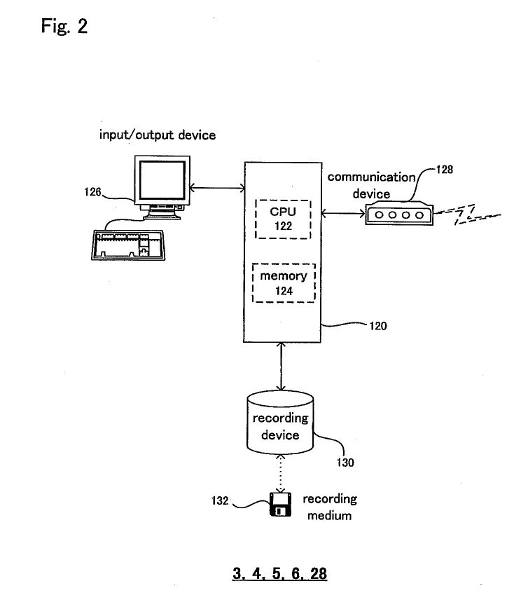

FIG. 2 is a diagram illustrating a hardware configuration of the SCIM server 3, the XML document management server (XDMS) 4, the application server (AS) 5, the home subscriber server (HSS) 6, and the S-CSCF server 28, which are shown in FIG. 1. As shown in FIG. 2, each of the SCIM server 3, the XML document management server (XDMS) 4, the application server (AS) 5, the home subscriber server (HSS) 6, and the S-CSCF server 28 includes: a main body 120 including a CPU 122 and a memory 124; input/output devices 126 including a keyboard and a display device; a communication device 128 for performing communication with another node; and a recording device 130 for performing recording and reproduction of data with respect to a recording medium 132, including a CD drive and an HD drive. In short, each of the SCIM server 3, the XML document management server (XDMS) 4, the application server (AS) 5, the home subscriber server (HSS) 6, and the S-CSCF server 28 includes hardware entities of a computer capable of information processing and communication with another node.

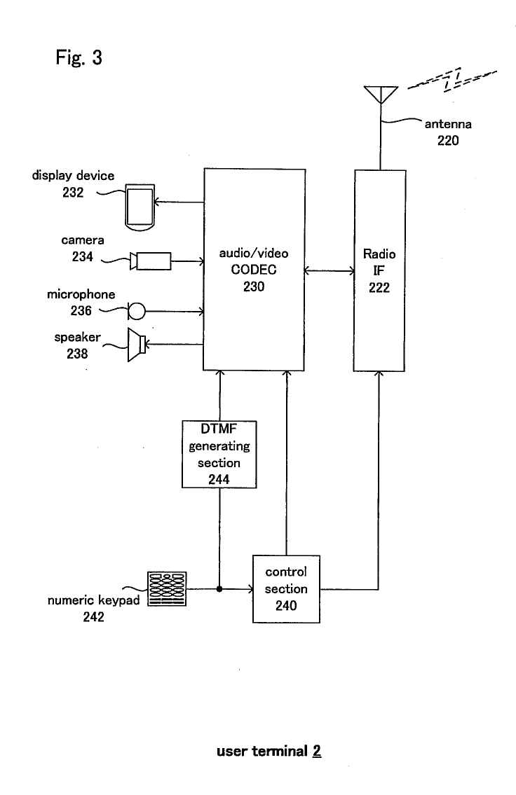

FIG. 3 is a diagram illustrating a hardware configuration of the user terminal 2 of FIG. 1. As shown in FIG. 3, the user terminal 2 includes an antenna 220, a radio I/F 222, an audio/video CODEC 230, a display device 232 such as an LCD, a camera 234, a microphone 236, a speaker 238, a control section 240, a numeric keypad 242, and a dial tone multi frequency (DTMF) generating section 244. Note that each of the entities of the user terminal 2 may be realized by dedicated hardware, or may be realized by software executed on a digital signal processor (DSP) or the like.

The antenna 220 and the radio I/F 222 perform transmission of a signal necessary for setting a line with respect to the radio base station 20. The antenna 220 and the radio I/F 222 also perform transmission of an audio, video, and DTMF signal with respect to another user terminal 2 or another node via the radio base station 20 and the network 100. The display device 232, for example, a liquid crystal display device, displays a video generated by the audio/video CODEC 230, and presents the video to the user. The camera 234, for example, a CCD camera, takes images of a user and scenery to generate a video, and outputs the video to the audio/video CODEC 230. The microphone 236 receives an audio such as a user's voice, and outputs the audio to the audio/video CODEC 230. The speaker 238 outputs an audio inputted from the audio/video CODEC 230, for example, a voice of a person at the other end of the line or an audio associated with service information.

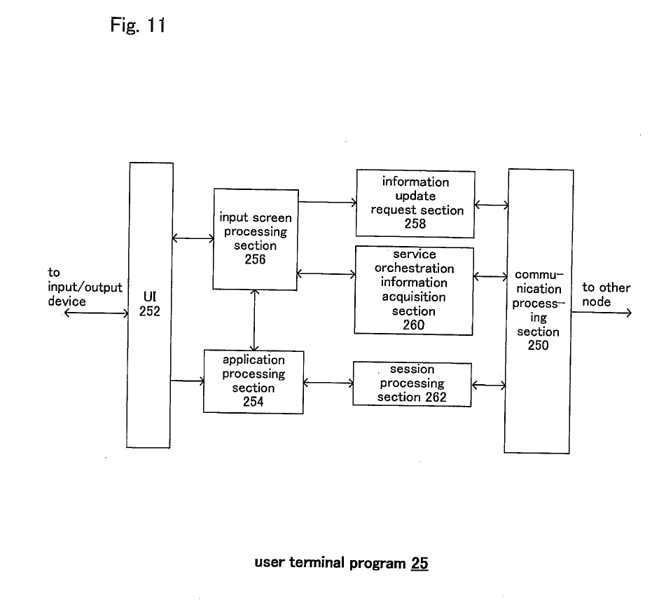

The numeric keypad 242 has buttons of the numbers 0 to 9 and the symbols including “*” and “#”, which are suitable for a signal input operation based on the DTMF, and functions to receive a user's operation and output the user's operation to the control section 240 and the DTMF generating section 244. The control section 240 includes a CPU and memory (not shown), and executes such a program as described later with reference to FIG. 11 to perform a processing for communication with the radio base station 20, a processing for control of each entity of the user terminal 2, and the like. The control section 240 performs the processing for communication with the radio base station 20, and outputs a signal for the communication to the radio I/F 222. The control section 240 further performs the processing for control of each entity of the user terminal 2, and outputs a signal for the control to the audio/video CODEC 230. In response to the user's operation with respect to the buttons of the numeric keypad 242, the DTMF generating section 244 generates DTMF signals corresponding to the numbers 0 to 9 and the symbols including “*” and “#”, and outputs the DTMF signals to the audio/video CODEC 230.

The audio/video CODEC 230 receives video data in, for example, an MPEG format, which has been transmitted from another user terminal 2 and another node, via the radio I/F 222, decodes the video data, and displays the video data on the display device 232. The audio/video CODEC 230 decodes audio data, which has been transmitted from another user terminal 2 and another node, and outputs the audio data from the speaker 238. The audio/video CODEC 230 also encodes a video inputted from the camera 234 into video data in an MPEG format, and outputs the video data to the radio I/F 222. The audio/video CODEC 230 further encodes an audio inputted from the microphone 236 and a DTMF signal inputted from the DTMF generating section 244 into audio data, and outputs the audio data to the radio I/F 222. In short, the user terminal 2 includes hardware entities capable of transmitting an audio, video, and DTMF signal to another node.

SCIM Program 30

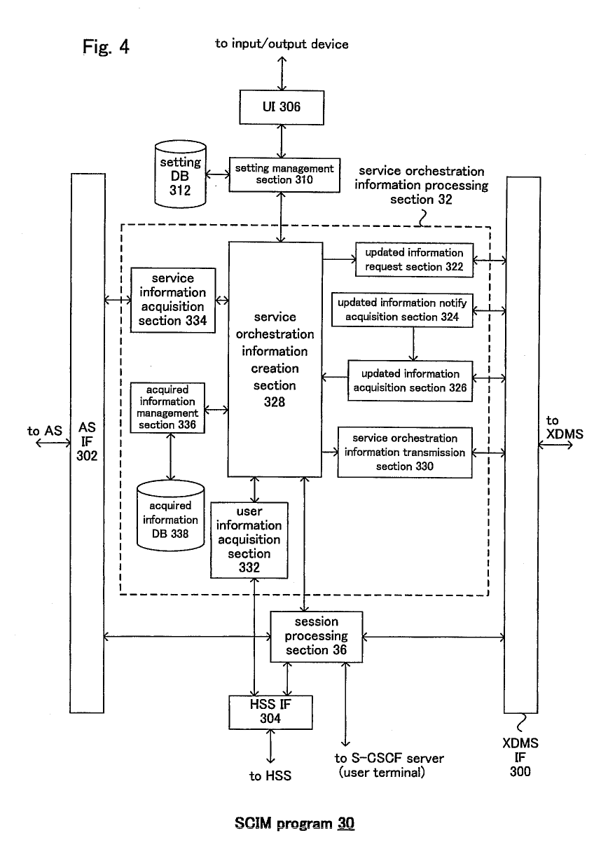

FIG. 4 is a diagram illustrating a configuration of an SCIM program 30 that runs on the SCIM server 3 shown in FIG. 1. As shown in FIG. 4, the SCIM program 30 includes an XDMS I/F 300, an AS I/F 302, an HSS I/F 304, a user interface (UI) 306, a setting management section 310, a setting DB 312, a service orchestration information processing section 32, and a session processing section 36. The SCIM program 30 is, for example, supplied to the SCIM server 3 via the recording medium 132 (FIG. 2), loaded onto the memory 124, and executed on an OS (not shown) installed on the SCIM server 3 by use of hardware resources of the SCIM server 3 in a concrete manner (the same applies to each software described below). Note that in this embodiment, the SCIM server 3 is connected to the XML document management server (XDMS) 4, the XML document management server (XDMS) 4, the application server (AS) 5, the home subscriber server (HSS) 6, and the S-CSCF server 28, but if another component is included in the system, may be connected to the another component.

In the SCIM program 30, the XDMS I/F 300 is connected to the service orchestration information processing section 32 and the session processing section 36 via, for example, session initiation protocol (SIP) and XML configuration access protocol (XCAP). The XCAP used herein represents a protocol for storing, modifying, and deleting a document described in XML using the hypertext transfer protocol (HTTP) or other such document. The XDMS I/F 300 performs a processing including protocol conversion necessary for the service orchestration information processing section 32 and the session processing section 36 to transmit/receive information to/from the XML document management server (XDMS) 4. The XDMS I/F 300 also receives information from the service orchestration information processing section 32 and the session processing section 36, performs a necessary processing, and transmits the information to the XML document management server (XDMS) 4. The XDMS I/F 300 further receives information from the XML document management server (XDMS) 4, performs a necessary processing, and transmits the information to the service orchestration information processing section 32 and the session processing section 36.

The AS I/F 302 is connected to the service orchestration information processing section 32 and the session processing section 36 via, for example, SIP, and performs a processing including protocol conversion necessary for the service orchestration information processing section 32 and the session processing section 36 to transmit/receive information to/from the application server (AS) 5. The AS I/F 302 also receives information from the service orchestration information processing section 32 and the session processing section 36, performs a necessary processing, and transmits the information to the application server (AS) 5. The AS I/F 302 further receives information from the application server (AS) 5, performs a necessary processing, and transmits the information to the service orchestration information processing section 32 and the session processing section 36. The HSS I/F 304 is connected to the service orchestration information processing section 32 and the session processing section 36 via, for example, an Sh interface, and performs a processing including protocol conversion necessary for the service orchestration information processing section 32 and the session processing section 36 to transmit/receive information to/from the home subscriber server (HSS) 6.

The HSS I/F 304 also receives information from the service orchestration information processing section 32 and the session processing section 36, performs a necessary processing, and transmits the information to the home subscriber server (HSS) 6. The HSS I/F 304 further receives information from the home subscriber server (HSS) 6, performs a necessary processing, and transmits the information to the service orchestration information processing section 32 and the session processing section 36.

The UI 306 receives an operation of a system administrator with respect to an input/output device, outputs its operation signal to a setting management section 310, and also controls a processing of the setting management section 310. When the setting management section 310 receives the operation signal from the UI 306, based on the operation signal, the setting management section 310 changes settings for a service orchestration information creation section 328 to create service orchestration information. The settings include a setting relating to a service selection and a setting relating to a selection of a service participant. The setting management section 310 also stores information on the changed settings (setting information) in the setting DB 312, and manages the setting information. Further, according to the control of the service orchestration information creation section 328, the setting management section 310 outputs the setting information stored in the setting DB 312 to the service orchestration information creation section 328.

The service orchestration information processing section 32 includes an updated information request section 322, an updated information notify acquisition section 324, an updated information acquisition section 326, the service orchestration information creation section 328, a service orchestration information transmission section 330, a user information acquisition section 332, a service information acquisition section 334, an acquired information management section 336, and an acquired information database (DB) 338. The service orchestration information processing section 32 collects information through those configuration portions from the XML document management server (XDMS) 4, the application server (AS) 5, and the home subscriber server (HSS) 6, and performs a processing necessary for creating service orchestration information. The service orchestration information processing section 32 further performs a processing for storing the created service orchestration information in the XML document management server (XDMS) 4.

The service orchestration information creation section 328 performs a processing for creating service orchestration information, and controls the other entities of the service orchestration information processing section 32. According to the control of the service orchestration information creation section 328, the updated information request section 322 transmits an updated information request to the XML document management server (XDMS) 4 via the XDMS I/F 300 and the network 100 by using, for example, SIP_SUBSCRIBE. The updated information request used herein represents an instruction for such control that if information stored in the XML document management server (XDMS) 4 is updated, a node that has requested for the updated information be notified thereof. The updated information request section 322 also receives a response, for example, a 200_OK response, which is transmitted by the XML document management server (XDMS) 4 upon reception of the updated information request, via the XDMS I/F 300 and the network 100. Note that in this embodiment, the 200_OK response is used as the response to be returned by each configuration portion upon reception of a request or the like to a node that has transmitted the request, but any format may be used instead of the 200_OK response.

The updated information notify acquisition section 324 receives an updated information notify, which has been transmitted by the XML document management server (XDMS) 4 in response to the updated information request, via the XDMS I/F 300 and the network 100 by using, for example, SIP_NOTIFY, and outputs the updated information notify to the updated information acquisition section 326. Upon reception of the updated information notify, the updated information acquisition section 326 transmits to the XML document management server (XDMS) 4 an instruction for requesting to transmit the updated information via the XDMS I/F 300 and the network 100 based on the updated information notify. The updated information acquisition section 326 also acquires information transmitted by the XML document management server (XDMS) 4 in response to the request, and outputs the information to the service orchestration information creation section 328.

According to the control of the service orchestration information creation section 328, the user information acquisition section 332 transmits an instruction for requesting to transmit user information to the home subscriber server (HSS) 6 via the HSS I/F 304 and the network 100. The user information acquisition section 332 also acquires the user information transmitted by the home subscriber server (HSS) 6 in response to the request, and outputs the user information to the service orchestration information creation section 328.

According to the control of the service orchestration information creation section 328, the service information acquisition section 334 transmits an instruction for requesting to transmit service information to the application server (AS) 5 via the AS I/F 304 and the network 100. The service information acquisition section 334 also acquires the service information transmitted by the home subscriber server (HSS) 6 in response to the request, and outputs the service information to the service orchestration information creation section 328. The service orchestration information creation section 328 outputs the acquired updated information, user information, and service information to the acquired information management section 336. The acquired information management section 336 stores information received from the service orchestration information creation section 328 in the acquired information database (DB) 338, and manages the information. Further, according to the control of the service orchestration information creation section 328, the acquired information management section 336 outputs the information stored in the acquired information database (DB) 338 to the service orchestration information creation section 328.

The service orchestration information creation section 328 creates service orchestration information based on the information acquired from the respective entities and the setting information stored in the setting DB 312, and outputs the created service orchestration information to the service orchestration information transmission section 330. For example, if the setting information contains a criterion such as “providing a service (game or the like) involving as many participants as possible”, the service orchestration information creation section 328 retrieves a past history from the updated information stored in the acquired information database (DB) 338, and creates the service orchestration information that satisfies the criterion. Note that in a case where service orchestration information to be created contains an entity to be selected by the user of the user terminal 2, the service orchestration information creation section 328 adds a candidate entity status to the service orchestration information, and outputs the resultant information as service orchestration candidate entity information.

In this specification, the case where the service orchestration information contains an entity to be selected by the user of the user terminal 2 represents, for example, a case that requires a selection of a user who is to join a service relating to the service orchestration information, or a selection of a service to be joined from among a plurality of services. The service orchestration information transmission section 330 transmits the service orchestration information received from the service orchestration information creation section 328 to the XML document management server (XDMS) 4 via the XDMS I/F 300 and the network 100 via, for example, XCAP.

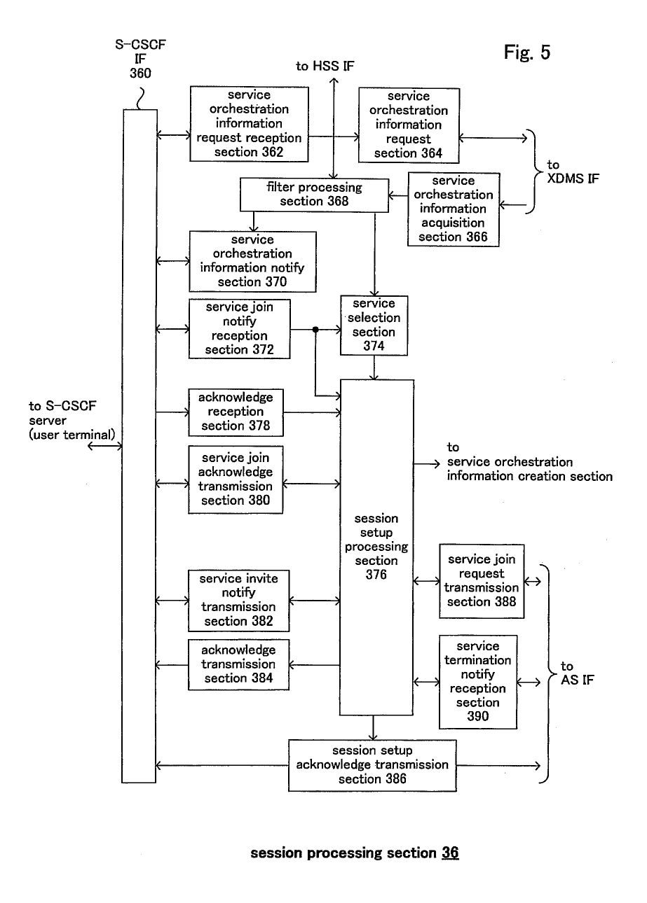

FIG. 5 is a diagram illustrating a configuration of the session processing section 36 shown in FIG. 4. As shown in FIG. 5, the session processing section 36 includes an S-CSCF I/F 360, a service orchestration information request reception section 362, a service orchestration information request section 364, a service orchestration information acquisition section 366, a filter processing section 368, a service orchestration information notify section 370, a service join notify reception section 372, a service selection section 374, a session setup processing section 376, an acknowledge reception section 378, a service join acknowledge transmission section 380, a service invite notify transmission section 382, an acknowledge transmission section 384, a session setup acknowledge transmission section 386, a service join request transmission section 388, and a service termination notify reception section 390. The session processing section 36 uses those configuration portions to perform a processing for setting up a session between the user terminal 2 and the application server (AS) 5.

In the session processing section 36, the S-CSCF I/F 360 is connected to the other entities within the session processing section 36 via, for example, SIP. The S-CSCF I/F 360 performs a processing including protocol conversion necessary for the other entities within the session processing section 36 to transmit/receive information to/from the S-CSCF server 28. The S-CSCF I/F 360 also receives information from another entity within the session processing section 36, performs a necessary processing, and transmits the information to the S-CSCF server 28. The information transmitted to the S-CSCF server 28 is transmitted to the user terminal 2 by the S-CSCF server 28. The S-CSCF I/F 360 further receives from the S-CSCF server 28 the information, which has been received by the S-CSCF server 28 from the user terminal 2, performs a necessary processing, and transmits the information to another entity within the session processing section 36.

The service orchestration information request reception section 362 receives a request (service orchestration information request) to transmit the service orchestration information from the user terminal 2, via the S-CSCF server 28, the network 100, and the S-CSCF I/F 360 by using, for example, SIP_SUBSCRIBE. The service orchestration information request reception section 362 also outputs the service orchestration information request to the service orchestration information request section 364. Further, upon reception of the service orchestration information request, the service orchestration information request reception section 362 transmits the 200_OK response to the user terminal 2 via the S-CSCF I/F 360, the network 100, and the like.

Upon reception of the service orchestration information request, the service orchestration information request section 364 transmits the service orchestration information request to the XML document management server (XDMS) 4 via the XDMS I/F 300 and the network 100 by using, for example, SIP_SUBSCRIBE. The service orchestration information request section 364 receives the 200_OK response, which is transmitted by the XML document management server (XDMS) 4 upon reception of the service orchestration information request, via the XDMS I/F 300 and the network 100. The service orchestration information acquisition section 366 receives the service orchestration information, which has been transmitted by the XML document management server (XDMS) 4 in response to the service orchestration information request, via the XDMS I/F 300 and the network 100 by using, for example, SIP_NOTIFY, and outputs the service orchestration information to the filter processing section 368.

The filter processing section 368 acquires the user information from the home subscriber server (HSS) 6 via the HSS I/F 304 and the network 100. The filter processing section 368 also receives the service orchestration information from the service orchestration information acquisition section 366. Further, the filter processing section 368 performs a filter processing on the service orchestration information based on the user information, and outputs the resultant service orchestration information to the service orchestration information notify section 370 and the service selection section 374.

The service orchestration information notify section 370 outputs the service orchestration information to the user terminal 2 via the S-CSCF I/F 360, the network 100, and the like by using, for example, SIP_NOTIFY. The service orchestration information notify section 370 also receives the 200_OK response, which is transmitted by the user terminal 2 upon reception of the service orchestration information, via the S-CSCF I/F 360 and the network 100. The service join notify reception section 372 receives a service join notify from the user terminal 2 via the S-CSCF I/F 360, the network 100, and the like by using, for example, SIP_INVITE. Upon reception of the service join notify, the service join notify reception section 372 also transmits the 200_OK response to the user terminal 2 via the S-CSCF I/F 360, the network 100, and the like. Further, the service join notify reception section 372 outputs the service join notify to the service selection section 374 and the session setup processing section 376.

The service selection section 374 selects a service to be provided to the user terminal 2 from the service orchestration information outputted from the filter processing section 368 and from the service join notify outputted from the service join notify reception section 372. The service selection section 374 also outputs service information relating to the selected service to the session setup processing section 376.

The session setup processing section 376 performs a processing necessary for setting up a session between the user terminal 2 and the application server (AS) 5 that provides a plurality of services composing the selected services. The acknowledge reception section 378 receives an acknowledge, which is transmitted by the user terminal 2 in response to the 200_OK response from the service join notify reception section 372, by using, for example, ACK, and outputs the acknowledge to the session setup processing section 376. Upon reception of the acknowledge from the user terminal 2, the session setup processing section 376 transmits to the service join request transmission section 388 an instruction to transmit a service join request to the application server (AS) 5.

The service join request transmission section 388 transmits the service join request to the application server (AS) 5 that provides the corresponding services via the AS I/F 302 and the network 100 by using, for example, SIP_INVITE. The service join request transmission section 388 also receives the 200_OK response, which is transmitted by the application server (AS) 5 upon reception of the service join request, via the AS I/F 302 and the network 100. Further, the service join request transmission section 388 outputs the received 200_OK response to the session setup processing section 376. Upon reception of the 200_OK response from the application server (AS) 5, the session setup processing section 376 transmits to the service join acknowledge transmission section 380 an instruction to transmit a service join acknowledge to the user terminal 2.

The service join acknowledge transmission section 380 transmits the service join acknowledge to the user terminal 2 via the S-CSCF I/F 360, the network 100, and the like by using, for example, SIP_INVITE. The service join acknowledge transmission section 380 also receives the 200_OK response, which is transmitted by the user terminal 2 upon reception of the service join acknowledge, via the S-CSCF I/F 360, the network 100, and the like. Further, the service join acknowledge transmission section 380 outputs the received 200_OK response to the session setup processing section 376.

Upon reception of the 200_K response from the user terminal 2, the session setup processing section 376 transmits to the session setup acknowledge transmission section 386 an instruction to transmit a session setup acknowledge to the user terminal 2 and to the application server (AS) 5 that provides the corresponding services. In response to the instruction issued from the session setup processing section 376, the session setup acknowledge transmission section 386 transmits the session setup acknowledge to the user terminal 2 and the application server (AS) 5 by using, for example, ACK. According to the above-mentioned processing, a session is set up between the user terminal 2 and the application server (AS) 5. When the session is set up, a predetermined service is provoked. In other words, the application server (AS) 5 starts to provide the service to the user terminal 2.

If the acquired service orchestration information contains a list of members who are to join the service, the session setup processing section 376 outputs to the service invite notify transmission section 382 an instruction to transmit a service invite notify to the user terminal 2 of users included in the list. The service invite notify used herein represents a notify for inquiring whether or not to join the service, and is transmitted by use of, for example, SIP_INVITE. In response to the instruction issued from the session setup processing section 376, the service invite notify transmission section 382 transmits the service invite notify to the user terminal 2 via the S-CSCF I/F 360, the network 100, and the like by using, for example, SIP_INVITE. The service invite notify transmission section 382 receives the 200_OK response, which is transmitted by the user terminal 2 upon reception of the service invite notify, via the S-CSCF I/F 360, the network 100, and the like. The service invite notify transmission section 382 also outputs the received 200_OK response to the session setup processing section 376.

Upon reception of the 200_OK response from the user terminal 2, the session setup processing section 376 transmits to the acknowledge transmission section 384 an instruction to transmit an acknowledge to the user terminal 2. In response to the instruction issued from the session setup processing section 376, the acknowledge transmission section 384 transmits a session setup acknowledge to the user terminal 2 by using, for example, ACK.

From the application server (AS) 5 that has set up a session with the user terminal 2 and is providing a service to the user terminal 2, the service termination notify reception section 390 receives a service termination notify that notifies that the session has been terminated via the AS I/F 302 and the network 100 by using, for example, SIP_BYE. Upon reception of the service termination notify, the service termination notify reception section 390 transmits the 200_OK response to the application server (AS) 5. The service termination notify reception section 390 also outputs the service termination notify to the session setup processing section 376. Upon reception of the service termination notify, the session setup processing section 376 performs a processing for terminating the session between the user terminal 2 and the application server (AS) 5.

XDMS Program 40

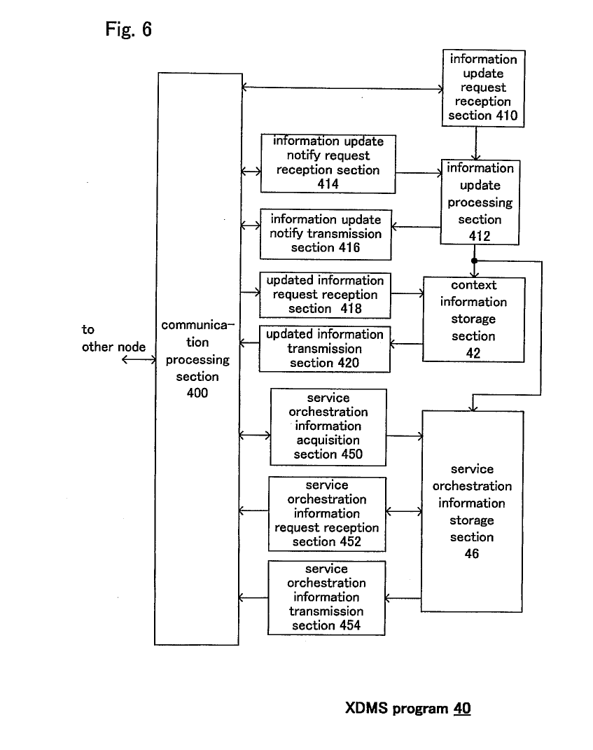

FIG. 6 is a diagram illustrating a configuration of an XDMS program 40 that runs on the XML document management server (XDMS) 4 shown in FIG. 1. As shown in FIG. 6, the XDMS program 40 includes a communication processing section 400, an information update request reception section 410, an information update processing section 412, an information update notify request reception section 414, an information update notify transmission section 416, an updated information request reception section 418, an updated information transmission section 420, a context information storage section 42, a service orchestration information acquisition section 450, a service orchestration information request reception section 452, a service orchestration information transmission section 454, and a service orchestration information storage section 46.

In the XDMS program 40, the communication processing section 400 performs a processing necessary for communicating with another node via the network 100. The information update request reception section 410 receives a request (information update request) for updating information stored in the XML document management server (XDMS) 4 from another node via the network 100 and the communication processing section 400 via, for example, XCAP, and outputs the information update request to the information update processing section 412. Upon reception of the information update request from another node, the information update request reception section 410 transmits the 200_OK response to the another node.

Upon reception of the information update request from the information update request reception section 410, the information update processing section 412 performs a processing for updating information stored in the context information storage section 42 and the service orchestration information storage section 46 in response to the information update request. The information update notify request reception section 414 receives a request (information update notify request) for notifying that the information stored in the XML document management server (XDMS) 4 has been updated from another node via the network 100 and the communication processing section 400 by using, for example, SIP_SUBSCRIBE, and outputs the information update notify request to the information update processing section 412. The information update notify request reception section 414 transmits the 200_OK response to the node that has transmitted the information update notify request. Upon reception of the information update notify request from the information update notify request reception section 414, the information update processing section 412 performs a processing, for example, a flag processing, for transmitting an information update notify if the information corresponding to the information update notify request is updated. Further, when receiving the information update request corresponding to the information update notify request from the information update request reception section 410, the information update processing section 412 transmits the information update notify to the information update notify transmission section 416.

Upon reception of the information update notify from the information update processing section 412, the information update notify transmission section 416 transmits the information update notify to the node that has transmitted the information update notify request via the network 100 by using, for example, SIP_NOTIFY. The information update notify transmission section 416 also receives the 200_OK response, which is transmitted by the above-mentioned node upon reception of the information update notify, via the network 100. The updated information request reception section 418 receives a request (updated information request) for transmitting from another node an updated information from among the information stored in the XML document management server (XDMS) 4 via, for example, XCAP, and outputs the updated information request to the context information storage section 42. The context information storage section 42 outputs the updated information to the updated information transmission section 420 in response to the received updated information request. The updated information transmission section 420 transmits the updated information outputted from the context information storage section 42 to the node that has transmitted the updated information request via the network 100.

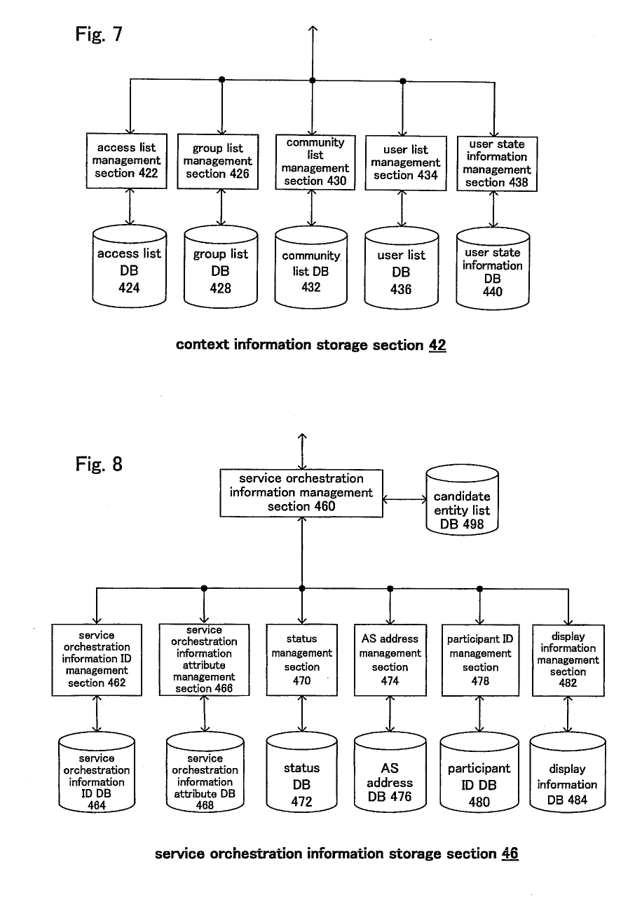

FIG. 7 is a diagram illustrating a configuration of the context information storage section 42 shown in FIG. 6. As shown in FIG. 7, the context information storage section 42 includes an access list management section 422, an access list DB 424, a group list management section 426, a group list DB 428, a community list management section 430, a community list DB 432, a user list management section 434, a user list DB 436, a user state information management section 438, and a user state information DB 440. Note that the configuration of the context information storage section 42 and a configuration of context information stored in the context information storage section 42 are not limited to the configuration shown in FIG. 7, and may be expanded as appropriate.

In the context information storage section 42, the access list management section 422 stores an access list for filtering access from a predetermined network in the access list DB 424, and manages the access list. The access list management section 422 also outputs the access list stored in the access list DB 424 to the updated information transmission section 420 as necessary. The user can appropriately change the access list to thereby deny the access from, for example, a given server.

The group list management section 426 stores a group list that contains information on a group using the system in the group list DB 428, and manages the group list. The group list management section 426 also outputs the group list stored in the group list DB 428 to the updated information transmission section 420 as necessary. The community list management section 430 stores a community list that contains information on a community using the system in the community list DB 432, and manages the community list. The community list management section 430 also outputs the community list stored in the community list DB 432 to the updated information transmission section 420 as necessary.

The user list management section 434 stores a user list that contains information on a user using the system in the user list DB 436, and manages the user list. The user list management section 434 also outputs the user list stored in the user list DB 436 to the updated information transmission section 420 as necessary. The user state information management section 438 stores a user state information that contains information on a state of the user using the system in the user state information DB 440, and manages the user state information. The user state information includes, for example, location information of a specific user, information on a usable terminal or the like, and information on the S-CSCF server 28 or the radio base station 20 communicating with the user terminal 2. The user state information management section 438 also outputs the user state information stored in the user state information DB 440 to the updated information transmission section 420 as necessary.

The service orchestration information acquisition section 450 (FIG. 6) receives the service orchestration information from the SCIM server 3 via, for example, XCAP, and outputs the service orchestration information to the service orchestration information storage section 46. The service orchestration information storage section 46 stores the service orchestration information outputted from the service orchestration information acquisition section 450, and manages the service orchestration information.

The service orchestration information request reception section 452 receives a service orchestration information request from another node, and transmits the service orchestration information request to the service orchestration information storage section. Upon reception of the service orchestration information request, the service orchestration information request reception section 452 also transmits the 200_OK response to the node that has transmitted the service orchestration information request. In response to the service orchestration information request transmitted from the service orchestration information request reception section 452, the service orchestration information storage section 46 retrieves the service orchestration information, and outputs the service orchestration information to the service orchestration information transmission section 454. The service orchestration information transmission section 454 transmits the service orchestration information outputted from the service orchestration information storage section 46 to the node that has transmitted the service orchestration information request.

FIG. 8 is a diagram illustrating a configuration of the service orchestration information storage section 46 shown in FIG. 6. As shown in FIG. 8, the service orchestration information storage section 46 includes a service orchestration information management section 460, a service orchestration information ID management section 462, a service orchestration information ID DB 464, a service orchestration information attribute management section 466, a service orchestration information attribute DB 468, a status management section 470, a status DB 472, an AS address management section 474, an AS address DB 476, a participant ID management section 478, a participant ID DB 480, a display information management section 482, a display information DB 484, and a candidate entity list DB 498. Note that the configuration of the service orchestration information storage section 46 and a configuration of the service orchestration information stored in the service orchestration information storage section 46 are not limited to the configuration shown in FIG. 8, and may be expanded as appropriate.

The service orchestration information management section 460 controls the processing of each configuration portion within the service orchestration information storage section 46. The service orchestration information management section 460 receives the service orchestration information from the service orchestration information acquisition section 450, and according to the information contained in the received service orchestration information, outputs the service orchestration information to each configuration portion within the service orchestration information storage section 46. If the candidate entity status is contained in the service orchestration information received from the service orchestration information acquisition section 450, the service orchestration information management section 460 stores an ID of the service orchestration information in the candidate entity list DB 498. In response to the information update request transmitted from the information update processing section 412, the service orchestration information management section 460 also controls an update processing of the service orchestration information. Further, in response to the service orchestration information request transmitted from the service orchestration information request reception section 452, the service orchestration information management section 460 retrieves the service orchestration information, and outputs the retrieved service orchestration information to the service orchestration information transmission section 454. The service orchestration information management section 460 also searches the candidate entity list DB 498 to retrieve the service orchestration information, and, if the ID of the corresponding service orchestration information exists, performs a processing of adding the candidate entity status to the service orchestration information.

The service orchestration information ID management section 462 stores an ID of the service orchestration information in the service orchestration information ID DB 464, and manages the ID. The service orchestration information ID management section 462 also outputs the ID of the service orchestration information stored in the service orchestration information ID DB 464 to the service orchestration information management section 460 as necessary. The service orchestration information attribute management section 466 stores an attribute of the service orchestration information in the service orchestration information attribute DB 468, and manages the attribute. The service orchestration information attribute management section 466 also outputs the attribute of the service orchestration information stored in the service orchestration information attribute DB 468 to the service orchestration information management section 460 as necessary.

The status management section 470 stores a status of the service orchestration information in the status DB 472, and manages the status. The status management section 470 also outputs the status stored in the status DB 472 to the service orchestration information management section 460 as necessary. The AS address management section 474 stores an address of the application server (AS) 5 that provides a service constituting the service orchestration information in the AS address DB 476, and manages the AS address. The AS address management section 474 also outputs the address of the AS stored in the AS address DB 476 to the service orchestration information management section 460 as necessary.

The participant ID management section 478 stores an ID of a participant who can join the service corresponding to the service orchestration information in the participant ID DB 480, and manages the ID. The participant ID management section 478 also outputs the ID of the participant stored in the participant ID DB 480 to the service orchestration information management section 460 as necessary. The display information management section 482 stores display information to be displayed on the display device 232 of the user terminal 2 in terms of the service orchestration information in the display information DB 484, and manages the display information. The display information management section 482 also outputs the display information stored in the display information DB 484 to the service orchestration information management section 460 as necessary.

AS Program 50

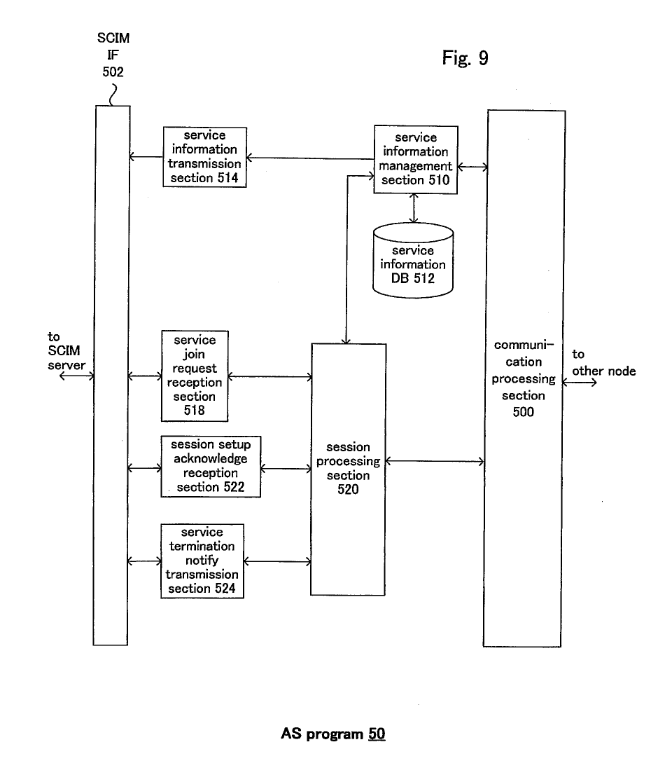

FIG. 9 is a diagram illustrating a configuration of an application server (AS) program 50 that runs on the application server (AS) 5 shown in FIG. 1. As shown in FIG. 9, the AS program 50 includes a communication processing section 500, an SCIM I/F 502, a service information management section 510, a service information DB 512, a service information transmission section 514, a service join request reception section 518, a session setup acknowledge reception section 522, a session processing section 520, and a service termination notify transmission section 524.

In the AS program 50, the communication processing section 500 performs a processing necessary for communicating with another node (including the SCIM server 3) via the network 100. The SCIM I/F 502 is connected to the other entities within the AS program 50 via, for example, SIP. The SCIM I/F 502 performs a processing including protocol conversion necessary for the other entities within the AS program 50 to transmit/receive information to/from the SCIM server 3. The SCIM I/F 502 also receives information from another entity within the AS program 50, performs a necessary processing, and transmits the information to the SCIM server 3. The SCIM I/F 502 further receives information from the SCIM server 3, performs a necessary processing, and transmits the information to another entity within the AS program 50.

The service information management section 510 manages the service stored in the service information DB 512 and service information relating to the service. In response to a request issued by another node, the service information management section 510 also performs a processing of transmitting the service stored in the service information DB 512 and the service information relating to the service. After setting up a session with the user terminal 2, the service information management section 510 executes provision of a predetermined service to the user terminal 2. The service information transmission section 514 transmits the service information to the SCIM server 3 via the SCIM I/F 502 and the network 100.

The service join request reception section 518 receives the service join request from the SCIM server 3 via the SCIM I/F 502 and the network 100 by using, for example, SIP_INVITE, and outputs the service join request to the session processing section 520. Upon reception of the service join request from the SCIM server 3, the service join request reception section 518 transmits the 200_OK response to the SCIM server 3 via the SCIM I/F 502 and the network 100. The session setup acknowledge reception section 522 receives the session setup acknowledge from the SCIM server 3 via the SCIM I/F 502 and the network 100 by using, for example, ACK, and outputs the session setup acknowledge to the session processing section 520.

Upon reception of the session setup acknowledge from the session setup acknowledge reception section 522, the session processing section 520 performs a processing necessary for setting up a session with the user terminal 2. In other words, in response to the service join request received from the service join request reception section 518, the session processing section 520 outputs to the service information management section 510 an instruction to provide the corresponding service to the user terminal 2. In response to the instruction, the service information management section 510 starts to provide the service to the user terminal 2. When the session is terminated, the session processing section 520 outputs the service termination notify to the service termination notify transmission section 524. The service termination notify transmission section 524 transmits the service termination notify received from the session processing section 520 to the SCIM server 3 via the SCIM I/F 502 and the network 100 by using, for example, SIP_BYE.

HSS Program 60

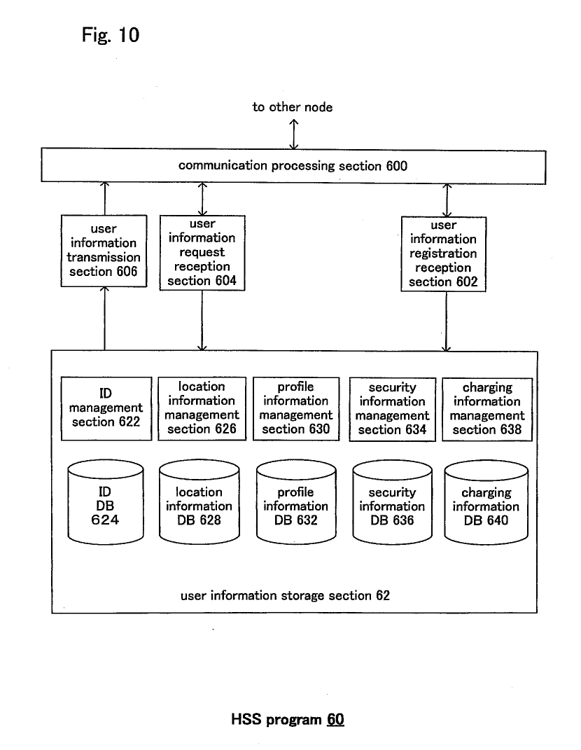

FIG. 10 is a diagram illustrating a configuration of a home subscriber server (HSS) program 60 that runs on the home subscriber server (HSS) 6 shown in FIG. 1. As shown in FIG. 10, the HSS program 60 includes a communication processing section 600, a user information registration reception section 602, a user information request reception section 604, a user information transmission section 606, and a user information storage section 62.

The communication processing section 600 performs a processing necessary for communicating with another node via the network 100. The user information registration reception section 602 receives user information registration from another node, and outputs the user information registration to the user information storage section 62. Upon reception of the user information registration from the user information registration reception section 602, the user information storage section 62 registers user information based on the user information registration.

The user information request reception section 604 receives a user information request from another node via, for example, the Sh interface, and outputs the user information request to the user information storage section 62. Upon reception of the user information request from the user information request reception section 604, the user information storage section 62 retrieves the user information based on the user information request, and outputs the retrieved user information to the user information transmission section 606. The user information transmission section 606 outputs the user information outputted from the user information storage section 62 to the node that has transmitted the user information request.

The user information storage section 62 includes an ID management section 622, an ID DB 624, a location information management section 626, a location information DB 628, a profile information management section 630, a profile information DB 632, a security information management section 634, a security information DB 636, a charging information management section 638, and a charging information DB 640. In the user information storage section 62, the ID management section 622 stores a user ID in the ID DB 624, and manages the user ID. The ID management section 622 also outputs the use ID stored in the ID DB 624 to the user information transmission section 606 as necessary. The location information management section 626 stores location information of the user in the location information DB 628, and manages the location information. The location information management section 626 also outputs the location information stored in the location information DB 628 to the user information transmission section 606 as necessary.

The profile information management section 630 stores profile information of the user in the profile information DB 632, and manages the profile information. The profile information management section 630 also outputs the profile information stored in the profile information DB 632 to the user information transmission section 606 as necessary. Note that the profile information includes information on the S-CSCF server 28 assigned for the user, an iFC for filtering the service, and registration information of the user.

The security information management section 634 stores security information of the user, which includes authorization information and approval information, in the security information DB 636, and manages the security information. The security information management section 634 also outputs the security information stored in the security information DB 636 to the user information transmission section 606 as necessary. The charging information management section 638 stores charging information of the user in the charging information DB 640, and manages the charging information. The charging information management section 638 also outputs the charging information stored in the charging information DB 640 to the user information transmission section 606 as necessary.

User Terminal Program 25

FIG. 11 is a diagram illustrating a configuration of a user terminal program 25 that runs on the user terminal 2 shown in FIG. 1. As shown in FIG. 11, the user terminal program 25 includes a communication processing section 250, a UI 252, an application processing section 254, an input screen processing section 256, an information update request section 258, a service orchestration information acquisition section 260, and a session processing section 262. In the user terminal program 25, the communication processing section 250 performs a processing necessary for communicating with another node via the network 100.

The UI 252 receives an operation of the user with respect to the input/output device such as the numeric keypad 242, outputs the operation to the application processing section 254 and the input screen processing section 256, and also controls processings of the other entities of the user terminal program 25. The application processing section 254 performs a processing necessary for executing an application incorporated into the user terminal 2. The input screen processing section 256 performs a processing for displaying on the display device 232 an input screen necessary for selection from the service orchestration candidate entity information or the updated information request by the user. In response to the operation of the user, the information update request section 258 transmits the updated information request to the XML document management server (XDMS) 4 via the network 100 and the like. The information update request section 258 also receives a response, which is transmitted by the XML document management server (XDMS) 4 upon reception of the updated information request, via the network 100 and the like.

In response to the operation of the user, the service orchestration information acquisition section 260 transmits the service orchestration information to the XML document management server (XDMS) 4. The service orchestration information acquisition section 260 receives a response containing the service orchestration information from the XML document management server (XDMS) 4 via the network 100 and the like, and outputs the response to the input screen processing section 256. If the service orchestration information received from the service orchestration information acquisition section 260 is the service orchestration candidate entity information (in other words, if the service orchestration information contains the candidate entity status), the input screen processing section 256 performs a processing for displaying a selection screen that allows the user's selection. The session processing section 262 performs a processing for setting up a session with the application server (AS) 5 under the control of the SCIM server 3.

Entire Operation of Service Provisioning System 1

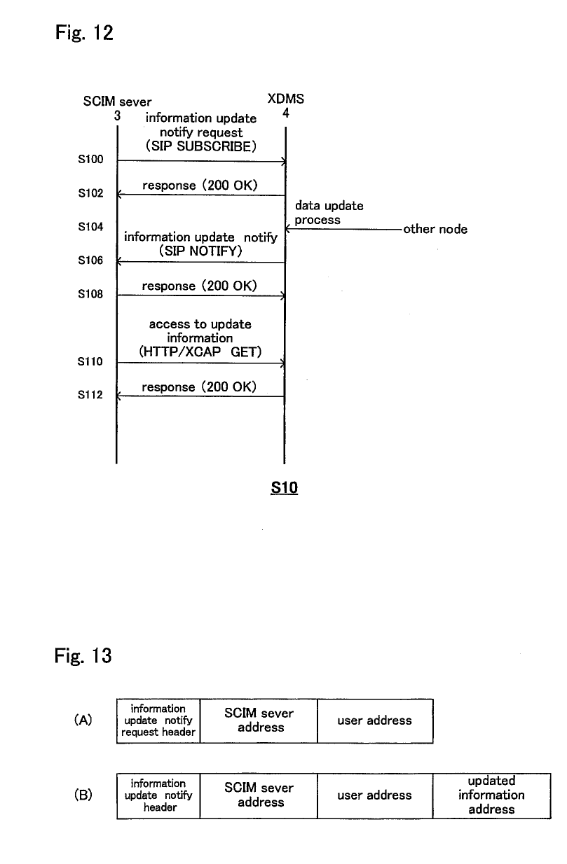

Hereinafter, description will be made of an entire operation of the service provisioning system 1. FIG. 12 is a sequence diagram (S10) exemplifying a mode in which the SCIM server 3 receives a notify from the XML document management server (XDMS) 4 and acquires updated information. As shown in FIG. 12, in Step 100 (S100), the SCIM server 3 transmits an update notify request to the XML document management server (XDMS) 4 by using, for example, SIP_SUBSCRIBE.

FIGS. 13(A) and 13(B) are diagrams exemplifying information exchanged between the respective nodes in the sequence shown in FIG. 12. FIG. 13(A) is a diagram exemplifying information transmitted from the SCIM server 3 to the XML document management server (XDMS) 4 in S100. As shown in FIG. 13(A), the update notify request contains an update notify request header, an SCIM server address, and a user address.

In Step 102 (S102) (FIG. 12), the XML document management server (XDMS) 4 transmits a response, for example, the 200_OK response, to the SCIM server 3. In Step 104 (S104), in response to the request from another node, the XML document management server (XDMS) 4 performs a processing of updating information on the user having the user address contained in the update notify request. In Step 106 (S106), the XML document management server (XDMS) 4 transmits an update notify to the SCIM server 3 by using SIP_NOTIFY. FIG. 13(B) is a diagram exemplifying information transmitted from the XML document management server (XDMS) 4 to the SCIM server 3 in S106. As shown in FIG. 13(B), the update notify contains an update notify header, the SCIM server address, the user address, and an updated information address.

In Step 108 (S108) (FIG. 12), the SCIM server 3 transmits the 200_OK response to the XML document management server (XDMS) 4. In Step 110 (S110), the SCIM server 3 accesses information within the XML document management server (XDMS) 4, which is indicated by the updated information address contained in the received update notify, by using, for example, HTTP/XCAP_GET. In Step 112 (S112), the XML document management server (XDMS) 4 transmits the 200_OK response containing the updated information to the SCIM server 3.

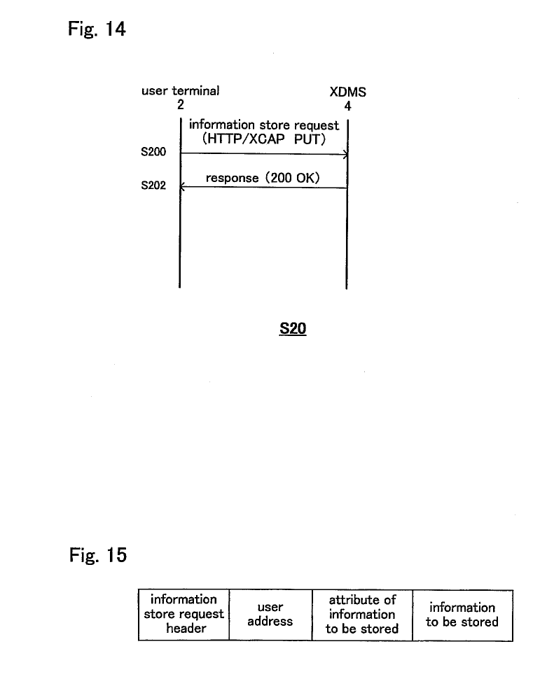

FIG. 14 is a sequence diagram (S20) exemplifying a mode in which the user terminal 2 stores information in the XML document management server (XDMS) 4. As shown in FIG. 14, in Step 200 (S200), the user terminal 2 transmits an information store request by using, for example, HTTP/XCAP_PUT. FIG. 15 is a diagram exemplifying information transmitted from the user terminal 2 to the XML document management server (XDMS) 4 in the sequence shown in FIG. 14. As shown in FIG. 15, in S200, the information store request contains an information store request header, a user address, an attribute of information to be stored, and information to be stored. In Step 202 (S202) (FIG. 14), the XML document management server (XDMS) 4 performs a processing of storing information based on the information store request, and transmits the 200_OK response to the user terminal 2.

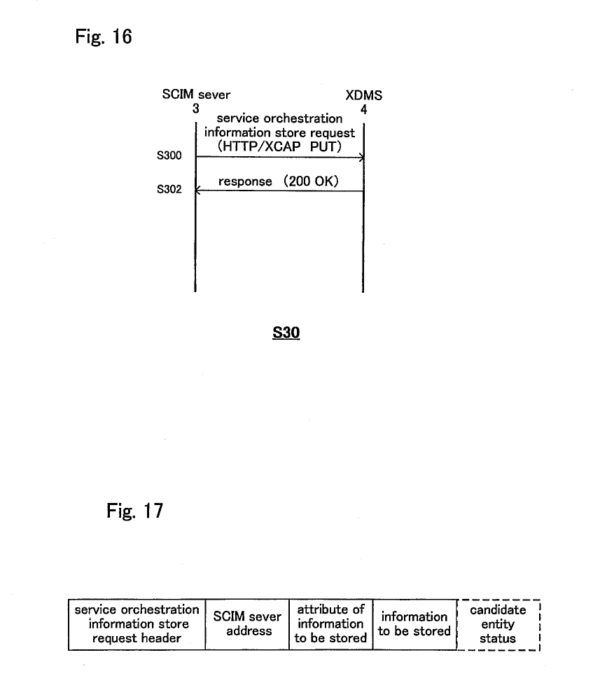

FIG. 16 is a sequence diagram (S30) exemplifying a mode in which the SCIM server 3 stores service orchestration information in the XML document management server (XDMS) 4. As shown in FIG. 16, in Step 300 (S300), the SCIM server 3 transmits a service orchestration information store request by using, for example, HTTP/XCAP_PUT. FIG. 17 is a diagram exemplifying information transmitted from the SCIM server 3 to the XML document management server (XDMS) 4 in the sequence shown in FIG. 16. As shown in FIG. 17, in S300, the service orchestration information store request contains a service orchestration information store request header, a SCIM server address, an attribute of information to be stored, and information to be stored. Note that if the service orchestration information is the service orchestration candidate entity information, the candidate entity status is contained therein as well. In Step 302 (S302) (FIG. 16), the XML document management server (XDMS) 4 performs a processing of storing information based on the service orchestration information store request, and transmits the 200_OK response to the SCIM server 3.

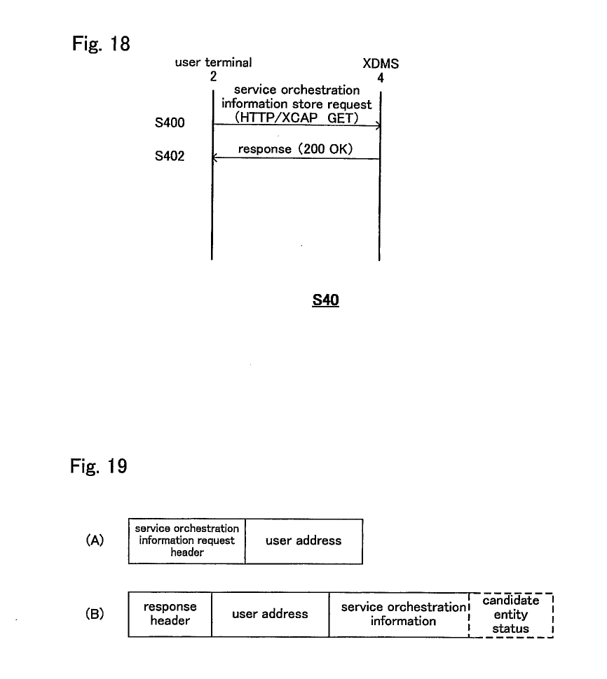

FIG. 18 is a sequence diagram (S40) exemplifying a mode in which the user terminal 2 acquires the service orchestration information from the XML document management server (XDMS) 4. This processing allows the user to acquire information on a currently available service. As shown in FIG. 18, in Step 400 (S400), the user terminal 2 outputs the service orchestration information acquisition request for acquiring the service orchestration information to the XML document management server (XDMS) 4 by using, for example, HTTP/XCAP_GET.

FIGS. 19(A) and 19(B) are diagrams exemplifying information exchanged between the respective nodes in the sequence shown in FIG. 18. FIG. 19(A) is a diagram exemplifying information transmitted from the user terminal 2 to the XML document management server (XDMS) 4 in S400. As shown in FIG. 19(A), the service orchestration information acquisition request contains a service orchestration information request header and a user address.

In Step 402 (S402) (FIG. 18), the XML document management server (XDMS) 4 retrieves the service orchestration information based on the user address contained in the service orchestration information acquisition request, and transmits the 200_OK response to the user terminal 2. FIG. 19(B) is a diagram exemplifying information transmitted from the XML document management server (XDMS) 4 to the user terminal 2 in S402. As shown in FIG. 19(B), the 200_OK response contains a response header, the user address, and service orchestration information. Note that if the service orchestration information is the service orchestration candidate entity information, the candidate entity status is contained therein as well.

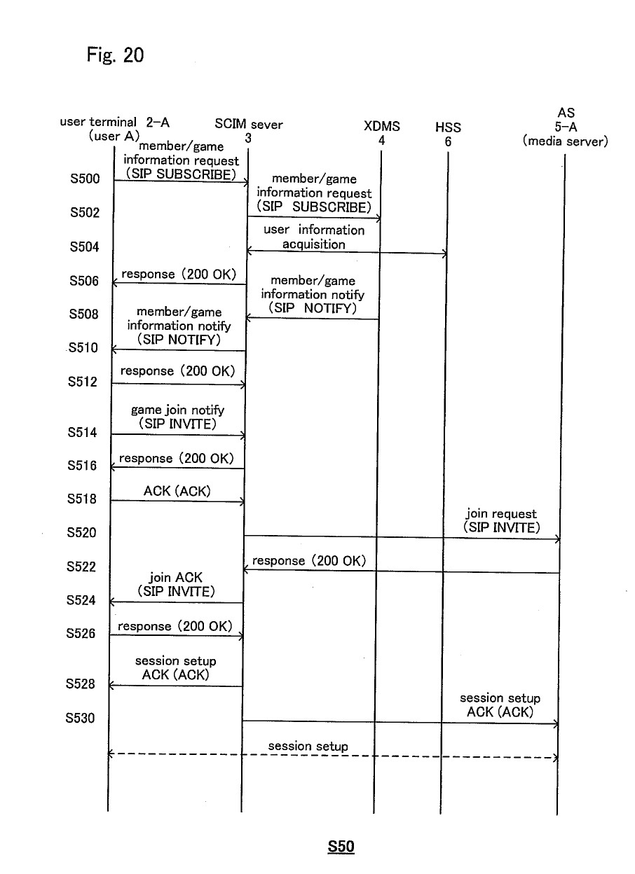

FIGS. 20, 22, and 24 are sequence diagrams (S50) exemplifying a mode in which the SCIM server 3 performs a processing for providing the user terminal 2 with a service based on the service orchestration information. In the examples shown in FIGS. 20, 22, and 24, the service is provided in the following manner. (1) A user A of a user terminal 2-A (A is an integer between 1 (inclusive) and N (inclusive)) requests the SCIM server 3 for information on an online game that the user A can join and a member who can join the online game. (2) The user A of the user terminal 2-A selects an online game that the user A wishes to join from the service orchestration candidate entity information outputted from the SCIM server 3. (3) The SCIM server 3 performs a processing of inquiring of a member that can join (in this example, a user B or the like) whether or not to join. (4) Before the start of the online game, a media session such as an advertisement is delivered from a media server to each user terminal 2. (5) The media session is followed by the start of the online game.

As shown in FIG. 20, in Step 500 (S500), the user terminal 2-A transmits a member/game information request to the SCIM server 3 by using, for example, SIP_SUBSCRIBE.

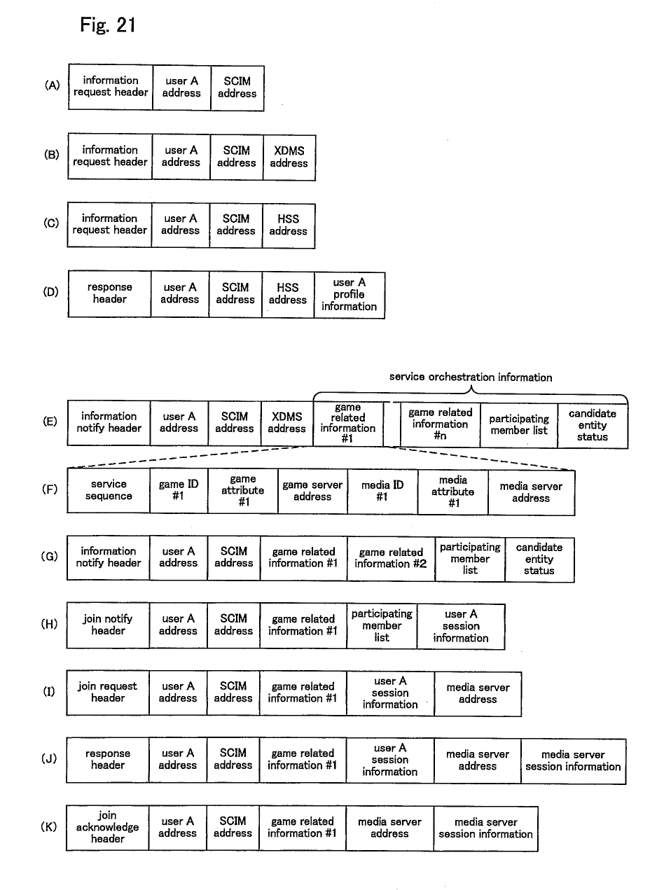

FIGS. 21(A)-(K) are diagrams exemplifying information exchanged between the respective nodes in the sequence shown in FIG. 20. FIG. 21(A) is a diagram exemplifying information transmitted from the user terminal 2-A to the SCIM server 3 in S500. As shown in FIG. 21(A), the member/game information request contains an information request header, a user A address, and an SCIM address.

In Step 502 (S502) (FIG. 20), the SCIM server 3 transmits the member/game information request to the XML document management server (XDMS) 4 by using, for example, SIP_SUBSCRIBE. FIG. 21(B) is a diagram exemplifying information transmitted from the SCIM server 3 to the XML document management server (XDMS) 4 in S502. As shown in FIG. 21(B), the member/game information request contains the information request header, the user A address, the SCIM address, and an XDMS address.

In Step 504 (S504) (FIG. 20), the SCIM server 3 acquires user information on the user A from the home subscriber server (HSS) 6. FIG. 21(C) is a diagram exemplifying information transmitted from the SCIM server 3 to the home subscriber server (HSS) 6 in S504. As shown in FIG. 21(C), the user information request contains the information request header, the user A address, the SCIM address, and an HSS address. FIG. 21(D) is a diagram exemplifying information transmitted from the home subscriber server (HSS) 6 to the SCIM server 3 in S506. As shown in FIG. 21(D), the response from the home subscriber server (HSS) 6 contains a response header, the user A address, the SCIM address, the HSS address, and a user A profile.

In Step 506 (S506) (FIG. 20), the SCIM server 3 returns a response such as the 200_OK response to the user terminal 2-A. In Step 508 (S508), the XML document management server (XDMS) 4 notifies the SCIM server 3 of the member/game information by using, for example, SIP_NOTIFY.

FIG. 21(E) is a diagram exemplifying information transmitted from the SCIM server 3 to the user terminal 2-A in S508. As shown in FIG. 21(E), the member/game information notify contains an information notify header, the user A address, the SCIM address, the XDMS address, game related information #1 to #n (n is an integer equal to or more than 2), a participating member list, and a candidate entity status. In this case, of those information, the service orchestration information includes the game related information #1 to #n, the participating member list, and the candidate entity status. FIG. 21(F) is a diagram illustrating a structure of the game related information #1. As shown in FIG. 21(F), the game related information #1 contains a service sequence, a game ID #1, a game attribute #1, a game server address, a media ID #1, a media attribute #1, and a media server address.

In Step 510 (S510) (FIG. 20), the SCIM server 3 notifies the user terminal 2-A of the member/game information by using, for example, SIP_NOTIFY based on the profile information on the user A acquired from the home subscriber server (HSS) 6. FIG. 21(G) is a diagram exemplifying information transmitted from the SCIM server 3 to the user terminal 2-A in S510. As shown in FIG. 21(G), the member/game information notify contains the information notify header, the user A address, the SCIM address, the game related information #1 and #2, the participating member list, and the candidate entity status. In this example, the SCIM server 3 performs a filtering processing on the game related information based on the profile information of the user A, and extracts only the game related information #1 and #2 from among the game related information #1 to #n before the transmission to the user A.

In Step 512 (S512) (FIG. 20), the user terminal 2-A returns the 200_Ok response to the SCIM server 3. In Step 514 (S514), the user terminal 2-A selects a game desired by the user A (in this example, game represented by the game related information #1) from among a plurality of game related information, and transmits a game join notify to the SCIM server 3 by using, for example, SIP_INVITE. FIG. 21(H) is a diagram exemplifying information transmitted from the user terminal 2-A to the SCIM server 3 in S514. As shown in FIG. 21(H), the game join notify contains a join notify header, the user A address, the SCIM address, the game related information #1, the participating member list, and user A session information. The session information used herein represents information containing information necessary for setting up a session, which is described according to, for example, a session description protocol (SDP).

In Step 516 (S516) (FIG. 20), the SCIM server 3 returns a response such as the 200_OK response to the user terminal 2-A. Note that this 200_OK response contains the session information on the SCIM server 3. In Step 518 (S518), the user terminal 2-A transmits an acknowledge to the SCIM server 3 by using, for example, ACK.

In Step 520 (S520), the SCIM server 3 transmits a join request for a session to an application server (AS) 5-A (A is an integer between 1 (inclusive) and M (inclusive)) functioning as the media server by using, for example, SIP_INVITE. FIG. 21(I) is a diagram exemplifying information transmitted from the SCIM server 3 to the application server (AS) 5-A in S520. As shown in FIG. 21(I), the join request contains a join request header, the user A address, the SCIM address, the game related information #1, the user A session information, and a media server (in this example, AS 5-A) address.

In Step 522 (S522) (FIG. 20), the application server (AS) 5-A returns the 200_OK response to the SCIM server 3. FIG. 21(J) is a diagram exemplifying information transmitted from the application server (AS) 5-A to the SCIM server 3 in S522. As shown in FIG. 21(J), the response returned from the application server (AS) 5-A contains a response header, the user A address, the SCIM address, the game related information #1, the user A session information, the media server address, and media server session information.

In Step 524 (S524) (FIG. 20), the SCIM server 3 transmits join acknowledge information to the user terminal 2-A by using, for example, SIP_INVITE. FIG. 21(K) is a diagram exemplifying information transmitted from the SCIM server 3 to the user terminal 2-A in S524. As shown in FIG. 21(K), the join acknowledge information contains a join acknowledge header, the user A address, the SCIM address, the game related information #1, the media server address, and the media server session information.

In Step 526 (S526) (FIG. 20), the user terminal 2-A returns a response such as the 200_OK response to the SCIM server 3. In Step 528 (S528), the SCIM server 3 transmits the session setup acknowledge to the user terminal 2-A by using, for example, ACK. In Step 530 (S530), the SCIM server 3 transmits the session setup acknowledge to the application server (AS) 5-A by using, for example, ACK. By the processings of S528 and S530, the session is set up between the user terminal 2-A and the application server (AS) 5-A, and the application server (AS) 5-A functioning as the media server delivers a media session to the user terminal 2-A.

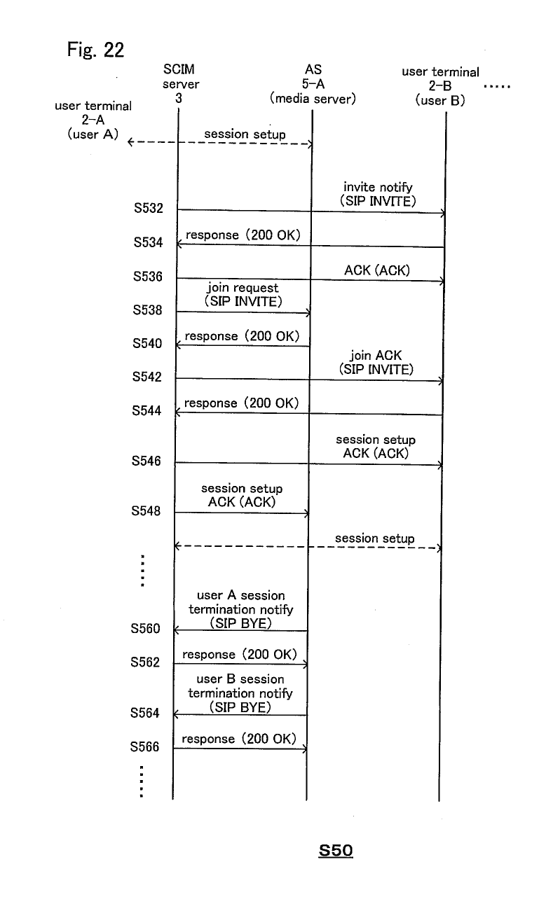

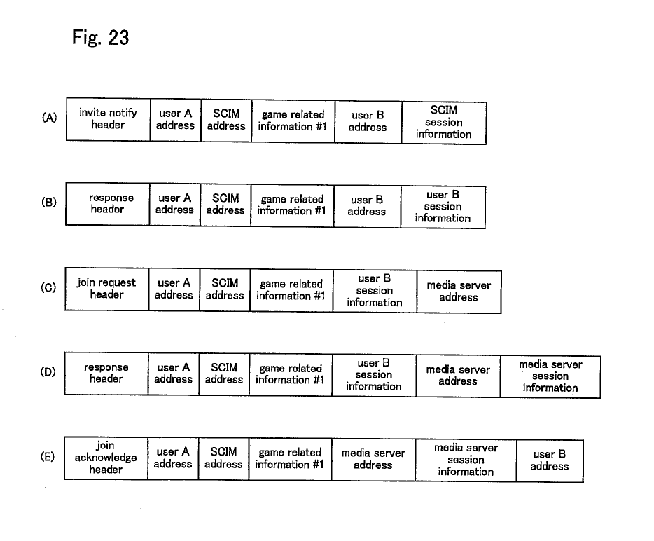

As shown in FIG. 22, in Step 532 (S532), the SCIM server 3 transmits an invite notify for the game to a user terminal 2-B by using, for example, SIP_INVITE. FIG. 23 are diagrams exemplifying information exchanged between the respective nodes in the sequence shown in FIG. 22. FIG. 23(A) is a diagram exemplifying information transmitted from the SCIM server 3 to the user terminal 2-B in S532. As shown in FIG. 23(A), the invite notify contains an invite notify header, the user A address, the SCIM address, the game related information #1, a user B address, and SCIM server session information.

In Step 534 (S534) (FIG. 22), the user terminal 2-B returns a response such as the 200_OK response to the SCIM server 3. FIG. 23(B) is a diagram exemplifying information transmitted from the user terminal 2-B to the SCIM server 3 in S534. As shown in FIG. 23(B), the response returned from the user terminal 2-B contains the response header, the user A address, the SCIM address, the game related information #1, the user B address, and user B session information.

In Step 536 (S536) (FIG. 22), the SCIM server 3 transmits an acknowledge to the user terminal 2-B by using, for example, ACK. In Step 538 (S538), the SCIM server 3 transmits the join request for a session to the application server (AS) 5-A by using, for example, SIP_INVITE. FIG. 23(C) is a diagram exemplifying information transmitted from the SCIM server 3 to the application server (AS) 5-A in S538. As shown in FIG. 23(C), the join request contains the join request header, the user A address, the SCIM address, the game related information #1, the user B session information, and the media server address.

In Step 540 (S540) (FIG. 22), the application server (AS) 5-A returns the 200_OK response to the SCIM server 3. FIG. 23(D) is a diagram exemplifying information transmitted from the application server (AS) 5-A to the SCIM server 3 in S540. As shown in FIG. 23(D), the response returned from the application server (AS) 5-A contains the response header, the user A address, the SCIM address, the game related information #1, the user B session information, the media server address, and the media server session information.

In Step 542 (S542) (FIG. 22), the SCIM server 3 transmits the join acknowledge information to the user terminal 2-B by using, for example, SIP_INVITE. FIG. 23(E) is a diagram exemplifying information transmitted from the SCIM server 3 to the user terminal 2-B in S542. As shown in FIG. 23(E), the join acknowledge information contains the join acknowledge header, the user A address, the SCIM address, the game related information #1, the media server address, the media server session information, and the user B address.

In Step 544 (S544) (FIG. 22), the user terminal 2-B returns a response such as the 200_OK response to the SCIM server 3. In Step 546 (S546), the SCIM server 3 transmits the session setup acknowledge to the user terminal 2-B by using, for example, ACK. In Step 548 (S548), the SCIM server 3 transmits the session setup acknowledge to the application server (AS) 5-A by using, for example, ACK. By the processings of S546 and S548, the session is set up between the user terminal 2-B and the application server (AS) 5-A, and the application server (AS) 5-A delivers the media session to the user terminal 2-B. Note that if a member other than the user B, who joins the game, exists, the processings of S532 to S548 are repeated based on the number of members.

In Step 560 (S560), the application server (AS) 5-A notifies the SCIM server 3 that the session with the user A has been terminated by using, for example, SIP_BYE. In Step 562 (S562), the SCIM server 3 returns a response such as the 200_OK response to the application server (AS) 5-A. In Step 564 (S564), the application server (AS) 5-A notifies the SCIM server 3 that the session with the user B has been terminated by using, for example, SIP_BYE. In Step 566 (S566), the SCIM server 3 returns a response such as the 200_OK response to the application server (AS) 5-A. Note that if a member other than the user B, who joins the game, exists, the processings of S564 to S566 are repeated based on the number of members.

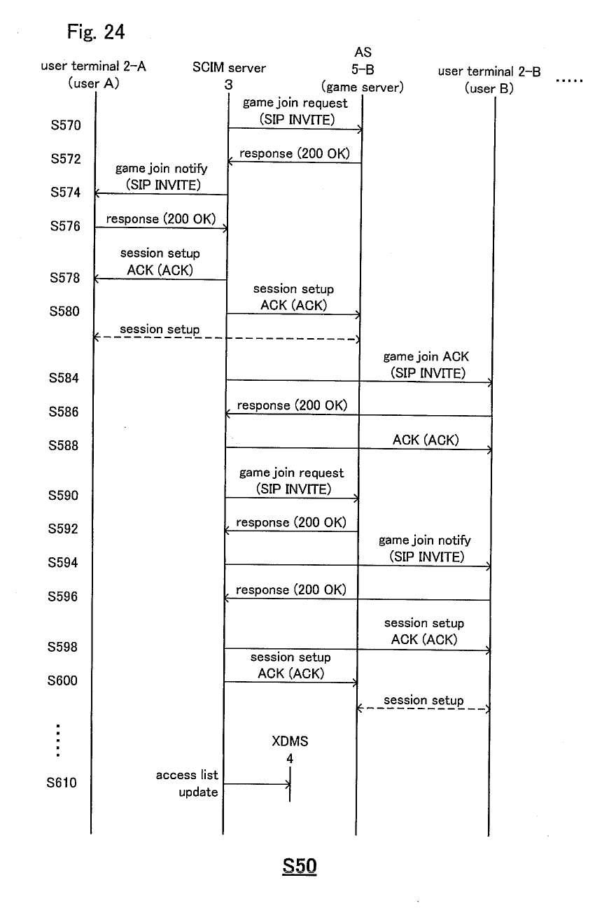

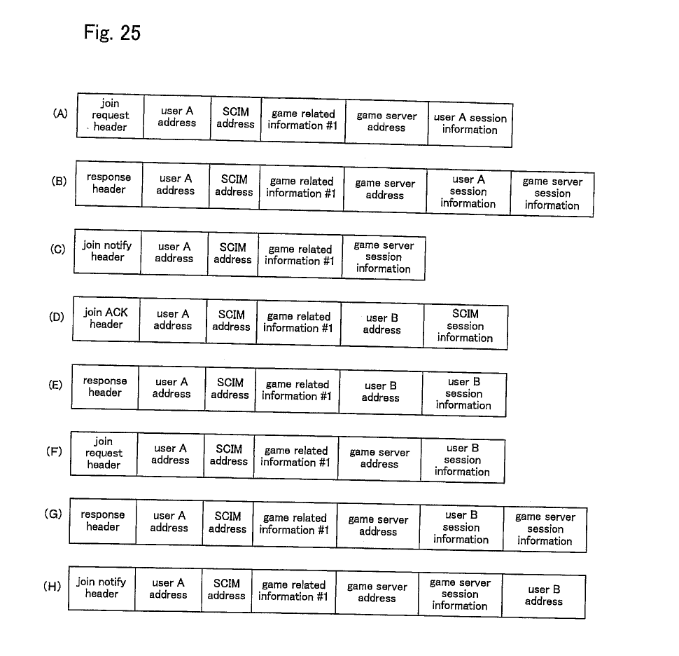

As shown in FIG. 24, in Step 570 (S570), the SCIM server 3 transmits the join request for the session to the application server (AS) 5-B (B is an integer between 1 (inclusive) and M (inclusive)) functioning as a game server by using, for example, SIP_INVITE. FIG. 25 are diagrams exemplifying information exchanged between the respective nodes in the sequence shown in FIG. 24. FIG. 25(A) is a diagram exemplifying information transmitted from the SCIM server 3 to the application server (AS) 5-B in S570. As shown in FIG. 25(A), the join request contains the join request header, the user A address, the SCIM address, the game related information #1, the game server (in this example, AS 5-B) address, and the user A session information.

In Step 572 (S572) (FIG. 24), the application server (AS) 5-B returns the 200_OK response to the SCIM server 3. FIG. 25(B) is a diagram exemplifying information transmitted from the application server (AS) 5-B to the SCIM server 3 in S572. As shown in FIG. 25(B), the response returned from the application server (AS) 5-B contains the response header, the user A address, the SCIM address, the game related information #1, the game server address, the user A session information, and game server session information.

In Step 574 (S574) (FIG. 24), the SCIM server 3 transmits a join notify to the user terminal 2-B by using, for example, SIP_INVITE. FIG. 25(C) is a diagram exemplifying information transmitted from the SCIM server 3 to the user terminal 2-A in S574. As shown in FIG. 25(C), the join notify contains the join notify header, the user A address, the SCIM address, the game related information #1, and the game server session information.

In Step 576 (S576) (FIG. 24), a response such as the 200_OK response is returned to the SCIM server 3. In Step 578 (S578), the SCIM server 3 transmits the session setup acknowledge to the user terminal 2-A by using, for example, ACK. In Step 580 (S580), the SCIM server 3 transmits the session setup acknowledge to the application server (AS) 5-B by using, for example, ACK. By the processings of S578 and S580, the session is set up between the user terminal 2-A and the application server (AS) 5-B, and the application server (AS) 5-B functioning as the game server delivers the game session to the user terminal 2-A.

In Step 584 (S584), the SCIM server 3 transmits game join acknowledge information to the user terminal 2-B by using, for example, SIP_INVITE. FIG. 25(D) is a diagram exemplifying information transmitted from the SCIM server 3 to the user terminal 2-B in S584. As shown in FIG. 25(D), the join acknowledge information contains the join acknowledge header, the user A address, the SCIM address, the game related information #1, the user B address, and the SCIM server session information.

In Step 586 (S586) (FIG. 24), the user terminal 2-B returns a response such as the 200_OK response to the SCIM server 3. FIG. 25(E) is a diagram exemplifying information transmitted from the user terminal 2-B to the SCIM server 3 in S586. As shown in FIG. 25(E), the response returned from the user terminal 2-B contains the response header, the user A address, the SCIM address, the game related information #1, the user B address, and the user B session information.

In Step 586 (S586) (FIG. 24), the SCIM server 3 transmits an acknowledge to the user terminal 2-B by using, for example, ACK. In Step 590 (S590), the SCIM server 3 transmits the join request for a session to the application server (AS) 5-B by using, for example, SIP_INVITE. FIG. 25(F) is a diagram exemplifying information transmitted from the SCIM server 3 to the application server (AS) 5-B in S590. As shown in FIG. 25(F), the join request contains the join request header, the user A address, the SCIM address, the game related information #1, the game server address, and the user B session information.

In Step 592 (S592) (FIG. 24), the application server (AS) 5-B returns the 200_OK response to SCIM server 3. FIG. 25(G) is a diagram exemplifying information transmitted from the application server (AS) 5-B to the SCIM server 3 in S592. As shown in FIG. 25(G), the response returned from the application server (AS) 5-B contains the response header, the user A address, the SCIM address, the game related information #1, the game server address, the user B session information, and the game server session information.

In Step 594 (S594) (FIG. 24), the SCIM server 3 transmits the join notify to the user terminal 2-B by using, for example, SIP_INVITE. FIG. 25(H) is a diagram exemplifying information transmitted from the SCIM server 3 to the user terminal 2-B in S594. As shown in FIG. 25(H), the join notify contains the join notify header, the user A address, the SCIM address, the game related information #1, the game server address, the game server session information, and the user B address.

In Step 596 (S596) (FIG. 24), the user terminal 2-B returns a response such as the 200_OK response to the SCIM server 3. In Step 598 (S598), the SCIM server 3 transmits the session setup acknowledge to the user terminal 2-B by using, for example, ACK. In Step 600 (S600), the SCIM server 3 transmits the session setup acknowledge to the application server (AS) 5-B by using, for example, ACK. By the processings of S598 and S600, the session is set up between the user terminal 2-B and the application server (AS) 5-B, and the application server (AS) 5-B delivers the game session to the user terminal 2-B.

Note that if a member other than the user B, who joins the game, exists, the processings of S584 to S600 are repeated based on the number of members. In Step 610 (S610), the SCIM server 3 transmits the update request for an access list to the XML document management server (XDMS) 4. Note that when the game session is terminated, the same processings as S560 to S566 shown in FIG. 22 are performed.

In this embodiment, the user terminal 2 is a mobile phone, but may be, for example, a PDA or a mobile PC. Also, the respective processings of the sequences exemplified in this embodiment may be changed in the sequence or the like as appropriate. Further, all of the formats such as SIP or XCAP illustrated in this embodiment are mere examples, and the processings may be executed according to another format.

### INDUSTRIAL APPLICABILITY

The present invention is applicable to the service provisioning system for providing the user terminal with a service.

### DESCRIPTION OF SYMBOLS

1 . . . service provisioning system
100 . . . network
20 . . . radio base station
2-1 to 2-N . . . user terminal
220 . . . antenna
222 . . . radio I/F
230 . . . audio/video CODEC
232 . . . display device
234 . . . camera
236 . . . microphone
238 . . . speaker
240 . . . control section
242 . . . numeric keypad
244 . . . dial tone multi frequency (DTMF) generating section
25 . . . user terminal program
250 . . . communication processing section
252 . . . user interface (UI)
254 . . . application processing section
256 . . . input screen processing section
258 . . . information update request section
260 . . . service orchestration information acquisition section
262 . . . session processing section
28 . . . serving call session control function (S-CSCF) server
120 . . . main body
122 . . . CPU
124 . . . memory
126 . . . input/output device
128 . . . communication device
130 . . . recording device
132 . . . recording medium
3 . . . SCIM server
30 . . . SCIM program
300 . . . XDMS I/F
302 . . . AS I/F
304 . . . HSS I/F
306 . . . user interface (UI)
310 . . . setting management section
312 . . . setting DB
32 . . . service orchestration information processing section
322 . . . updated information request section
324 . . . updated information notify acquisition section
326 . . . updated information acquisition section
328 . . . service orchestration information creation section
330 . . . service orchestration information transmission section
332 . . . user information acquisition section
334 . . . service information acquisition section
336 . . . acquired information management section
338 . . . acquired information database (DB)
36 . . . session processing section
360 . . . S-CSCF I/F
362 . . . service orchestration information request reception section
364 . . . service orchestration information request section
366 . . . service orchestration information acquisition section
368 . . . filter processing section
370 . . . service orchestration information notify section
372 . . . service join notify reception section
374 . . . service selection section
376 . . . session setup processing section
378 . . . acknowledge reception section
380 . . . service join acknowledge transmission section
382 . . . service invite notify transmission section
384 . . . acknowledge transmission section
386 . . . session setup acknowledge transmission section
388 . . . service join request transmission section
390 . . . service termination notify reception section
4 . . . XML document management server (XDMS)
40 . . . XDMS program
400 . . . communication processing section
410 . . . information update request reception section
412 . . . information update processing section
414 . . . information update notify request reception section
416 . . . information update notify transmission section
418 . . . updated information request reception section
420 . . . updated information transmission section
42 . . . context information storage section
422 . . . access list management section
424 . . . access list DB
426 . . . group list management section
428 . . . group list DB
430 . . . community list management section
432 . . . community list DB
434 . . . user list management section
436 . . . user list DB
438 . . . user state information management section
440 . . . user state information DB
450 . . . service orchestration information acquisition section
452 . . . service orchestration information request reception section
454 . . . service orchestration information transmission section
46 . . . service orchestration information storage section
460 . . . service orchestration information management section
462 . . . service orchestration information ID management section
464 . . . service orchestration information ID DB
466 . . . service orchestration information attribute management section
468 . . . service orchestration information attribute DB
470 . . . status management section
472 . . . status DB
474 . . . AS address management section
476 . . . AS address DB
478 . . . participant ID management section
480 . . . participant ID DB
482 . . . display information management section
484 . . . display information DB
498 . . . candidate entity list DB
5-1 to 5-M . . . application server (AS)
50 . . . AS program
500 . . . communication processing section
502 . . . SCIM I/F
510 . . . service information management section
512 . . . service information DB
514 . . . service information transmission section
518 . . . service join request reception section
522 . . . session setup acknowledge reception section
520 . . . session processing section
524 . . . service termination notify transmission section
6 . . . home subscriber server (HSS)
60 . . . HSS program
600 . . . communication processing section
602 . . . user information registration reception section
604 . . . user information request reception section
606 . . . user information transmission section
62 . . . user information storage section
622 . . . ID management section
624 . . . ID DB
626 . . . location information management section
628 . . . location information DB
630 . . . profile information management section
632 . . . profile information DB
634 . . . security information management section
636 . . . security information DB
638 . . . charging information management section
640 . . . charging information DB

What is claimed is:

1. A service provisioning system, comprising:
a plurality of service information management devices for managing first service information on a plurality of first services and providing the plurality of first services;
a service provisioning processing device for performing a processing for providing a second service to a user terminal; and
a service provisioning information management device for managing information for service provisioning that is used by the service provisioning processing device to provide the second service to a user,
wherein the service provisioning processing device comprises:
service generator for generating the second service based on the plurality of first service information;
service provisioning information creator for creating the service provisioning information;
service provisioning information storage device for causing the service provisioning information management device to store therein the service provisioning information; and
service provisioning information retrieving device for retrieving the service provisioning information from the service provisioning information management device.

2. The service provisioning system according to claim 1, wherein the service generator generates the second service by combining the plurality of pieces of first service information.

3. The service provisioning system according to claim 2, further comprising service invoking device for invoking the first service from the service information management device by using the second service,
whereby the service information management device provides the first service invoked by the service invoking device.

4. The service provisioning system according to claim 3, wherein:
the service provisioning processing device further comprises state information acquiring device for acquiring state information on another node,
whereby the service provisinging information creator creates the service provisioning information based on the state information.

5. The service provisioning system according to claim 4, wherein the service provisioning information management device further comprises:
service provisioning information updating device for updating the service provisioning information;
update notification request receiving device for receiving an update notification request from another node; and
update notification transmitting device for transmitting an update notification to the another node based on the update notification request if the service provisioning information is updated.

6. The service provisioning system according to claim 5, wherein the service provisioning processing device further comprises:
update notification requesting device for requesting the service provisioning information management device to transmit the update notification if the service provisioning information is updated; and
update notification receiving device for receiving the update notification from the service provisioning information management device.

7. The service provisioning system according to claim 6, wherein:
the service provisioning information includes:
a candidate entity service list that is used for the user terminal to select the second service; and
display information for displaying the candidate entity service list on the user terminal; and
the service provisioning processing device provides the second service selected by the user terminal.

8. The service provisioning system according to claim 7, further comprising a user information management device for managing user information on a user,
wherein the service provisioning processing device provides the second service based on the user information.

9. The service provisioning system according to claim 8, wherein:
the service provisioning processing device further comprises user information acquiring device for acquiring the user information from the user information management device; and
the service provisioning information creator creates the service provisioning information based on the user information.

10. A service provisioning processing device for performing a processing for providing a service to a user terminal, comprising:
service generator for generating a second service based on information on a first service;
service provisioning information creator for creating service provisioning information that is used for providing the second service; and
service providing device for providing the second service to the user terminal based on the service provisioning information.

11. A service provisioning method of providing a user terminal with a service, comprising:
a service information managing step of managing first service information on a first service;
a service generating step of generating a second service based on the first service information;
a service provisioning information creating step of creating the service provisioning information that is used for providing the second service;
a service provisioning information storing step of storing the service provisioning information;
a service provisioning information retrieving step of retrieving the service provisioning information stored by the service provisioning information storing step; and
a service provisioning step of providing the second service to the user terminal based on the service provisioning information.
